(19) United States
(12) Patent Application Publication
(10) Pub. No.: US 2008/0063804 A1
(43) Pub. Date: Mar. 13, 2008

(54) AUTODEPOSITION ON ALUMINUM ALLOYS FACILITATED BY MANGANESE OXIDE CONVERSION COATINGS

(76) Inventors: James O. Stoffer, Rolla, MO (US); Manesh Nadupparambil Sekharan, Troy, MI (US)

Correspondence Address: HOVEY WILLIAMS LLP, 10801 Mastin Blvd., Suite 1000, Overland Park, KS, 66210, US

(21) Appl. No.: 11/470,984

(22) Filed: Sep. 7, 2006

(51) Int. Cl. B05D 7/00

(52) U.S. Cl. 427/409

(57) ABSTRACT

Novel methods of forming films on metal or metal alloys are provided. These methods comprise the formation of a metal oxide (e.g., manganese oxide) conversion coating on the metal or metal alloy. The metal-oxide coated metal or metal alloy is then submerged in a mini-emulsion comprising the components (e.g., polymers, oligomers, and/or monomers) to be formed into a film or coating on the metal or metal alloy. The metal ions generated by the metal oxide coating will cause the components to coagulate and deposit on the metal or metal alloy.

### BACKGROUND OF THE INVENTION

1. Field of the Invention

The present invention is concerned with methods of using a manganese oxide conversion coating to effect formation of an organic coating on a metal or metal alloy substrate.

2. Description of the Prior Art

A relatively new method for the production of a polymer film onto metals is the autodeposition of the polymers onto a substrate. The coating is formed by immersion of metal parts into an acid bath containing the dispersed polymer, pigment, and other ingredients. The metal ions produced by the corrosion/dissolution process effected by the acidic bath acts as a coagulating agent at the metal-liquid interface to deposit the polymer along with the other dispersed ingredients. The destabilized polymer particles adhere at the metal surface. The deposition of the polymer continues due to the diffusion of metal cations though the polymer film, thus facilitating the further destabilization of the polymer as the film thickness increases until the film thickness is sufficient to slow down and/or stop the diffusion of the metal from the conversion coating. The coated articles are rinsed with water and dried (baked) at a sufficiently high temperature to enable the blocking of pores and the crosslinking of the polymer matrix.

The electrodeposition process can produce a similar type of coating, but in order to effect polymer deposition, the metal to be coated must be provided with a direct current to cause the destabilization of the polymer dispersion. Autodeposition has many advantages over electrodeposition, including the fact that no external electric current or voltage is necessary, which reduces energy consumption and increases operational safety. Autodeposition also saves procedure time and equipment space, and can reduce water and air pollution as no toxic components or organic solvents are used or required. The autodeposition process is diffusion-controlled and self-limiting in nature, which assists in controlling the coating thickness. Articles with any shape can be coated easily by an autodeposition process.

While the autodeposition process does provide advantages, these processes also suffer from drawbacks. For example, aluminum has a large, negative, standard electrode potential of −1.66V. Because of this large electrode potential, aluminum undergoes high corrosion activity (dissolution of aluminum) with significant hydrogen evolution in an acidic media. Vigorous hydrogen gas evolution is problematic in that the film formed on the metal surface is destroyed or becomes very non-continuous by the evolved gas, resulting in poor quality coatings. As a result, aluminum and similar metals are difficult to coat with prior art autodeposition processes.

There is a need for an autodeposition process that provides quality coatings on aluminum and similar metals.

### BRIEF DESCRIPTION OF THE DRAWINGS

FIG. 1 is a photograph showing a manganese oxide coating formed according to the invention after 45 seconds of immersion;

FIG. 2 is a photograph showing a manganese oxide coating formed according to the invention after 90 seconds of immersion;

FIG. 3 is a photograph showing a manganese oxide coating formed according to the invention after 3 minutes of immersion;

FIG. 4 is a scanning electron microscope (SEM) photograph showing a manganese oxide coating formed according to the invention after 45 seconds of immersion;

FIG. 5 is an SEM photograph showing a manganese oxide coating formed according to the invention after 90 seconds of immersion;

FIG. 6 is an SEM photograph showing a manganese oxide coating formed according to the invention after 3 minutes of immersion;

FIG. 7 is a graph showing the Energy Dispersive Spectra of the manganese oxide coating shown in FIGS. 3 and 6 (i.e., after 3 minutes of immersion);

FIG. 8 is a graph of an XPS analysis showing the Mn 2p signals from the manganese oxide coating shown in FIG. 1 (i.e., after 45 seconds of immersion);

FIG. 9 is a graph of an XPS analysis showing the Al 2p signals from the manganese oxide coating analyzed in FIG. 8;

FIG. 10 is a photograph showing a polymer coating formed on an aluminum alloy according to the invention;

FIG. 11 is a photograph showing the manganese oxide layer remaining below a polymer coating formed on an aluminum alloy according to the invention;

FIG. 12 is a photograph showing the results of an adhesion test after curing performed on a polymer coating formed on an aluminum alloy according to the invention;

FIG. 13 is a photograph showing the results of an adhesion test after curing performed on a polymer coating formed on an aluminum alloy according to the invention;

FIG. 14 is a photograph showing the results of an adhesion test after curing performed on a polymer coating formed on an aluminum alloy according to the invention;

FIG. 15 is a photograph showing the results of an adhesion test after curing performed on a polymer coating formed on an aluminum alloy according to the invention;

FIG. 16 is a photograph showing a polymer coating formed on an aluminum alloy according to a prior art process;

FIG. 17 is a photograph showing the hydrogen gas evolution encountered when hydrogen peroxide is added to an autodeposition coating bath; and

FIG. 18 is a photograph showing the polymer coating formed when hydrogen peroxide is added to the autodeposition coating bath as in FIG. 17.

### DETAILED DESCRIPTION OF THE PREFERRED EMBODIMENTS

The present invention overcomes the problems of the prior art by broadly providing a method of preparing a coated metal or metal alloy substrate. The method comprises providing a conversion-coated metal or metal alloy, which is then contacted with a composition or “autodeposition bath” comprising a component dissolved or dispersed in an aqueous system so as to cause the component to deposit on the metal oxide-coated metal or metal alloy and form the final coated metal or metal alloy.

The conversion coating on the metal or metal alloy must be soluble (or at least slightly soluble) in the autodeposition bath (acidic or basic media) with sufficient solubility to generate enough metal ions to cause coagulation of the polymer emulsion present in the autodeposition bath at a useful rate. A preferred conversion coating is a metal oxide coating. A metal oxide-coated metal or metal alloy can be prepared prior to use or can be obtained from another source. Possible conversion coating preparation procedures include electrodeposition and autodeposition processes, with autodeposition processes being preferred. In a preferred autodeposition process, a source of metal ions is dissolved in water to form an aqueous solution or “conversion coating bath.” Suitable metal ions are multivalent and exhibit sufficient solubility in the autodeposition bath as described above. Some preferred metal ions are ions of metals selected from the group consisting of the transition metals (which include the lanthanide and actinide series), zinc, and mixtures thereof. Particularly preferred metal ions comprise those selected from the group consisting of manganese ions, molybdenum ions, cerium ions, tungsten ions, vanadium ions, cobalt ions, zirconium ions, titanium ions, iron ions, zinc ions, copper ions, and mixtures thereof.

It is preferred that the metal ions be present in the conversion coating bath at levels of from about 0.1% to about 30% by weight, more preferably from about 0.1% to about 20% by weight, and even more preferably from about 0.1% to about 10% by weight metal ions, based upon the total weight of the conversion coating bath taken as 100% by weight. A preferred source of such metal ions would be oxides of transition metals, zinc, and mixtures thereof, with those selected from the group consisting of manganese, molybdenum, cerium, tungsten, vanadium, cobalt, zirconium, titanium, iron, zinc, copper, and mixtures thereof being particularly preferred.

It is preferred that the conversion coating bath also include an acid. The acid should be present in sufficient quantities to adjust the pH of the conversion coating bath to a level of from about 0 to about 5, and preferably from about 2 to about 4. Suitable acids include those selected from the group consisting of hydrochloric acid, sulfuric acid, nitric acid, phosphoric acid, the phosphonic acids, organic acids such as the chloroacetic acids (e.g., mono-, di-, and tri-chloroacetic acid), the fluoroacetic acids (e.g., mono-, di-, and tri-fluoroacetic acid), formic acid, methane sulfonic acid, the sulfonic acids with sufficient acid strength to give the desired pH, and mixtures thereof.

Once the conversion coating bath is prepared, the metal or metal alloy to be coated is at least partially (and preferably completely) immersed in the conversion coating bath. It is preferred that the metal or metal alloy be maintained in the conversion coating bath for a time period of from about 15 seconds to about 5 minutes, preferably from about 30 seconds to about 3 minutes, and even more preferably from about 45 seconds to about 2 minutes. During this time, the metal ions present in the bath will form a conversion coating (a metal oxide conversion coating in a preferred embodiment) on the surface of the metal or metal alloy. The conversion-coated metal or metal alloy is then preferably rinsed with water and allowed to dry. The thickness of the conversion coating will depend upon the metal ions utilized as well as the immersion time, however, preferred thicknesses are from about 10 nm to about 400 nm, and more preferably from about 25 nm to about 200 nm.

As briefly stated above, after the conversion-coated metal or metal alloy is prepared or obtained, as the case may be, it is then contacted with a composition or “autodeposition bath.” The autodeposition bath is preferably prepared by diluting a mini-emulsion with water, although traditional emulsions and micro-emulsions could also be used. The dilution should be such that the solids content of the autodeposition bath is from about 2% to about 15% by weight, preferably from about 3% to about 10% by weight, and even more preferably from about 5% to about 8% by weight, based upon the total weight of the autodeposition bath taken as 100% by weight.

It is preferred that the autodeposition bath also includes an acid. The acid should be present in sufficient quantities to adjust the pH of the autodeposition bath to a level of from about 0 to about 6, preferably from about 2 to about 4, and more preferably from about 2 to about 3. Suitable acids include those selected from the group consisting of hydrochloric acid, sulfuric acid, nitric acid, phosphoric acid, the phosphonic acids, organic acids such as the chloroacetic acids (e.g., mono-, di-, and tri-chloroacetic acid), fluoroacetic acids (e.g., mono-, di-, and tri-fluoroacetic acid), formic acid, the sulfonic acids, methane sulfonic acid, and mixtures thereof.

The mini-emulsion used to prepare the autodeposition bath provides the component dissolved or dispersed in the solvent system (typically an aqueous system with or without organic co-solvents that can be removed at the end of the polymerization process). As used herein, a mini-emulsion refers to submicron dispersions that are identified chiefly by their droplet size and relative stability. Typically, the mini-emulsion droplets are formed by high shear homogenization (e.g., via microfluidizers, sonifiers) of a crude emulsion. The combination of a stabilizer and a highly water insoluble costabilizer maintain the mini-emulsion stability against diffusional (Ostwald ripening) and collisional degradation.

The component in the mini-emulsion is selected from the group consisting of monomers, polymers, oligomers, and mixtures thereof. Preferred such components include those selected from the group consisting of epoxy resins, acrylates (e.g., methyl methacrylate, butyl acrylate), polyacrylates (e.g., polymethyl methacrylates, polybutyl acrylates), acrylic acids, polyacrylic acids, polyisocyanates, polyesters, polyurethanes, siloxanes, silicones, polyamides, polyolefins, di/poly hydroxyl functional polymer/oligomers, carbowaxes (preferably hydroxyl terminated), hydroxyl functional siloxanes, hydroxyl functional-silicones, hydroxyl functional-polyamides, hydroxyl functional-polyolefins, and mixtures thereof. The component is preferably present in the mini-emulsion at levels of from about 1% to about 50% by weight, and preferably from about 20% to about 40% by weight, based upon the total weight of solids in the mini-emulsion taken as 100% by weight.

The mini-emulsion preferably also includes an ingredient selected from the group consisting of crosslinking agents and catalysts. Preferred catalysts for the mini-emulsion preparation (i.e., to form the polymer in the mini-emulsion) includes peroxide free radical initiators such as benzoyl peroxide or methyl ethyl ketone peroxide, thermal initiators such as azobisisobutyronitrile, redox initiators such as ferric ions/hydrogen peroxide, and mixtures thereof. The catalyst is typically present at levels of from about 0.05% to about 3% by weight, and preferably from about 0.5% to about 11% by weight, based upon the total weight of polymerizable monomer in the mini-emulsion taken as 100% by weight.

Preferred crosslinking agents include those selected from the group consisting of blocked isocyanates, aminoplasts, blocked polyisocyanates, and blocked polycyanurates. The crosslinking agent is typically present at levels of from about 1% to about 30% by weight, and preferably from about 5% to about 15% by weight, based upon the total weight of the polymerizable component in the mini-emulsion taken as 100% by weight.

Preferred catalysts for the crosslinking process include: acid catalysts for aminoplasts (e.g., p-toluenesulfonic acid); and catalysts for the blocked isocynates (e.g., dialkyl metal dicarboxylates such as dibutyl tin dilurate). This catalyst is typically present at levels of from about 0.05% to about 3% by weight, and preferably from about 0.1% to about 0.5% by weight, based upon the total weight of crosslinking agent in the mini-emulsion taken as 100% by weight.

It will be appreciated that a number of optional ingredients could also be included in the mini-emulsion, depending upon the desired properties of the coating. Suitable optional ingredients include those selected from the group consisting of water, organic solvents, organic polymers, hexadecane or other hydrophobes typically used in mini-emulsion synthesis, additives, co-solvents, coloring agents, surfactants, pigments, anti-corrosion additives, coalescing co-solvents, and mixtures thereof.

The mini-emulsion is prepared by mixing the above ingredients in a solvent system (i.e., one or more solvents) to obtain a homogeneous solution. Suitable solvents for use in the solvent system include those selected from the group consisting of water, methyl ethyl ketone, methyl isobutyl ketone, glycolethers, glycolesters, and n-methyl pyrrolidone (NMP). This solution is then preferably added dropwise to a surfactant solution (e.g., 1% sodium dodecyl sulfate solution) while stirring to obtain a crude emulsion. That crude emulsion is preferably subjected to high shear conditions, such as ultrasonication for about 8-10 minutes, to obtain the mini-emulsion. Optionally, the solvent system can be removed by vacuum.

Once the mini-emulsion has been prepared and diluted to form the autodeposition bath as described above, the conversion-coated metal or metal alloy is contacted with that autodeposition bath. This contacting is preferably accomplished by at least partially (and preferably completely) immersing the conversion-coated metal or metal alloy substrate in the autodeposition bath. It is preferred that the conversion-coated metal or metal alloy be maintained in the autodeposition bath for a time period of from about 30 seconds to about 5 minutes, and preferably from about 1 minute to about 3 minutes.

The metal in the conversion coating that is present on the metal or metal alloy must be at least partially soluble at the pH levels present in the autodeposition bath. As a result, metal ions are generated from the conversion coating, and these metal ions cause coagulation of the mini-emulsion particles at the metal or metal alloy-liquid interface. The rate of metal ion generation is important; if it is too slow, the process is not commercially feasible, and if it is too fast, a poor coating quality is obtained. Preferably this rate of metal ion generation is from about 1 mg metal ions/ft²/minute to about 1,000 mg metal ions/ft²/minute, more preferably from about 10 mg metal ions/ft²/minute to about 500 mg metal ions/ft²/minute, and even more preferably from about 20 mg metal ions/ft²/minute to about 100 mg metal ions/ft²/minute.

The coagulation initiated by the metal ions leads to the deposition of the mini-emulsion particles onto the surface of the metal or metal alloy substrate to obtain the final coated metal or metal alloy piece or part. As the polymer/oligomer/monomer coating is formed on the metal or metal alloy, metal ions will continue to diffuse through the coating to some extent, thus continuing to induce further coagulation. This diffusion will decrease as the coating becomes thicker, so the process is self-limiting. Depending upon the initial thickness of the conversion coating and other bath parameters such as pH and time of immersion, the conversion coating can be either partially consumed so as to retain a thin layer of the conversion coating (e.g., a metal oxide layer) on the metal or metal alloy for additional protection, or the entire conversion coating can be consumed for the generation of sufficient metal ions.

The coated metal or metal alloy is subsequently air dried or heated (baked) to sufficient temperatures to induce crosslinking of the polymer, oligomer, and/or monomer so as to form a crosslinked coating oil the metal or metal alloy.

The thickness of the crosslinked coating will depend upon the polymers, oligomers, and/or monomers utilized as well as the immersion time, however, preferred thicknesses are from about 1 μm to about 100 μm, preferably from about 10 μm to about 50 μm, and even more preferably from about 15 μm to about 30 μm. The thickness can be measured using a Positector 6000 (available from Gardner Supplies) thickness gauge using ASTM No. D6132. The other properties of the coating (e.g., hardness, durability) will depend upon the desired final use of the coated metal or metal alloy.

One significant advantage of the present invention is that hydrogen evolution during the autodeposition process is minimal and can even be entirely avoided if the conversion coating sufficiently covers the active metal or metal alloy substrate. That is, the autodeposition step results in essentially no hydrogen being generated. Unlike prior art processes, the present invention avoids corrosion (dissolution) of the metal or metal alloy to be coated, thus avoiding, or at least minimizing, hydrogen evolution. This leads to a higher quality of coating that is essentially free of pinholes and other defects.

Another advantage of this invention is that the production of ions with the dissolution of the metal oxide conversion coating does not require the use of an oxidant in the autodeposition bath. As a result, the autodeposition bath is much more mild in terms of corrosion chemistry. Thus, the autodeposition bath is essentially free (i.e., less than about 1%, preferably less than about 0.05% by weight oxidant) of oxidants such as hydrogen peroxide.

Finally, it will be appreciated that virtually any metal or metal alloy can be coated according to the present invention. Exemplary metals and metal alloys include those selected from the group consisting of aluminum, magnesium, titanium, copper, bronze, iron, alloys of the foregoing, and any galvanized metal substrates. Aluminum and its alloys are widely used for the automotive frames, aircraft bodies, and numerous structural applications, so the ability to use this process with aluminum and its alloys is significant.

### EXAMPLES

The following examples set forth preferred methods in accordance with the invention. It is to be understood, however, that these examples are provided by way of illustration and nothing therein should be taken as a limitation upon the overall scope of the invention.

### Example 1

### 1. Materials

Epon 828, a general epoxy resin with an epoxy equivalent of 188, was obtained from Resolution Inc. Desmodur E 23 A, a polyisocyanate, was procured from Bayer. Adipic acid, sodium dodecyl sulfate (SDS), methyl ethyl ketone (MEK), methyl isobutyl ketone (MIBK) azobisisobutyronitrile (AIBN), methyl methacrylate (MMA), butyl acrylate (BA), and acrylic acid (AA) were purchased from Sigma Aldrich. Inhibitors were removed from the monomers (except for acrylic acid) by passing through an “inhibitor removal column” from Aldrich. Acrylic acid was used as received.

### 2. Chain Extension of Epoxy Resin

Epon 828 resin (150 gm), adipic acid (69.2 gm), and MIBK (25 gm) were charged into a 1,000-ml, four-necked resin kettle equipped with an electric stirrer. The ingredients were heated to 140° C. Benzyldimethylamine (0.5 gm) was added to the above mixture and allowed to exotherm to raise the temperature to 180° C. The reaction mixture was held at this temperature for half an hour. It was then cooled to 140° C., followed by the addition of 25 gm of MIBK and 0.5 gm of benzyldimethylamine. The temperature rose to 140-145° C., which was held until a final acid number value (ASTM D465) of 45 mg KOH/gm was reached.

### 3. Synthesis of Blocked Isocyanate

The following general procedure was adopted for blocking these polyisocyanates. The blocking agent (methyl ethyl ketoxime) was charged into a three-necked flask equipped with stirrer. A solution of polyisocyanate in MEK with 75-80% solids and 0.5-1.0% dibutyl tin dilaurate was added dropwise while maintaining the temperature below 60° C. The mixture was increased to, and held at, 60° C. for one hour, and then the temperature was raised to 80° C. where it was held for 3 hours. The blocked polyisocyanate was discharged at this temperature.

### 4. Preparation of Mini-Emulsion

Five different mini-emulsions were prepared, with the respective ingredients and quantities being set forth in Table 1. The chain extended epoxy resin and blocked polyisocyanates were mixed with acrylic acid, butyl acrylate, methyl methacrylate, AIBN initiator, and MEK. This polymer-monomer mixture was added dropwise to a 1% SDS Solution in distilled water under magnetic stirring and kept under stirring for 20 minutes to obtain a crude emulsion. The crude emulsion was ultrasonicated for 10 minutes under ice cooling. The monomer mini-emulsion was then transferred into a three-necked flask with a stirring assembly, and polymerized at 70-75° C. for 6 hours under an N₂ blanket. MEK was removed by vacuum distillation after completion of polymerization.

TABLE 1
Hybrid Mini-Emulsions

| | NUMBER | | | | |
|---|---|---|---|---|---|
| | 1 | 2 | 3 | 4 | 5 |
| | Weight | Weight | Weight | Weight | Weight |
| INGREDIENTS | (g) | (g) | (g) | (g) | (g) |
| Epoxy Resin | 0 | 0 | 0 | 15 | 15 |
| Blocked Isocyanate | 25 | 25 | 25 | 10 | 20 |
| MMA | 25 | 15 | 0 | 0 | 25 |
| HEMA | 8 | 8 | 8 | 0 | 0 |
| AA | 3 | 3 | 3 | 3 | 6 |
| BA | 17 | 27 | 42 | 50 | 25 |
| AIBN | 1.06 | 1.06 | 1.05 | 1.05 | 1.05 |
| Hexadecane | 2 | 2 | 2 | 2 | 2 |
| Water | 234 | 234 | 189 | 234 | 234 |
| SDS | 2.34 | 2.34 | 2 | 2 | 2.34 |
| MEK | 0 | 0 | 0 | 50 | 50 |

### 5. Autodeposition Bath Preparation

A non-pigmented, autodeposition bath was prepared to study the deposition of mini-emulsion latexes on aluminum alloy 7075 T-6. The mini-emulsion was diluted with deionized water and acidified with dilute hydrochloric acid under stirring to a pH of 2-3. Final emulsion solids were adjusted to between 5-8% by weight using distilled water.

### 6. Formation of Manganese Oxide Conversion Coating

KMnO₄ (30 gm) was dissolved in distilled water (750 gm), and 2N HCl (15 gm) was added to the above KMnO₄ solution. Aluminum 7075 T-6 alloy panels were rinsed with acetone and wiped with lintless paper. These panels were immersed in an alkaline cleaner, Turco TC 4415 (obtained from Henkel), at 60° C. for three minutes. The panels were later washed with tap water followed by distilled water. The above panels were immersed in the previously prepared KMnO₄ bath for 30 seconds to 3 minutes to form yellow to dark conversion coatings. The coated panels were washed with water and air dried.

### 7. Autodeposition of Organic Coating

The manganese oxide, conversion-coated, aluminum alloy panels were immersed in the autodeposition bath for 1-3 minutes. The MnO₂ is soluble at this pH to produce Mn²⁺ ions, which causes the coagulation of the emulsion particles at the interface to form a uniform coating free of pinholes and defects arising from hydrogen evolution as is the case with prior art non-manganese oxide coated panels.

### Results and Discussion

### 1. Analysis of Particle Size of Mini-Emulsion

The particle size of the polymerized mini-emulsion was measured using a dynamic light (DLS) scattering instrument. These measurements were performed on a Brookhaven (Brookhaven Instrumental Inc., Holtsville, N.Y.) Fiber Optic Quasi-Elastic Light Scattering Instrument (FOEQLS) at 25±0.1° C. The instrument was equipped with an 830 nm, 100 mW solid state laser with a scattering angle of 155°.

The average diameter of mini-emulsion polymers was between 115 and 160 nm.

### 2. Analysis of the Conversion Coating

a. SEM Analysis

Scanning electron microscope (SEM) images of the manganese oxide-aluminum oxide conversion coating were obtained using a Hitachi S-4700 field emission scanning electron microscope. Samples for SEM imaging were prepared by cutting 1 cm×1 cm pieces from the test coupons. Energy Dispersive Spectroscopic analysis was performed to identify the elemental composition of the oxide layer.

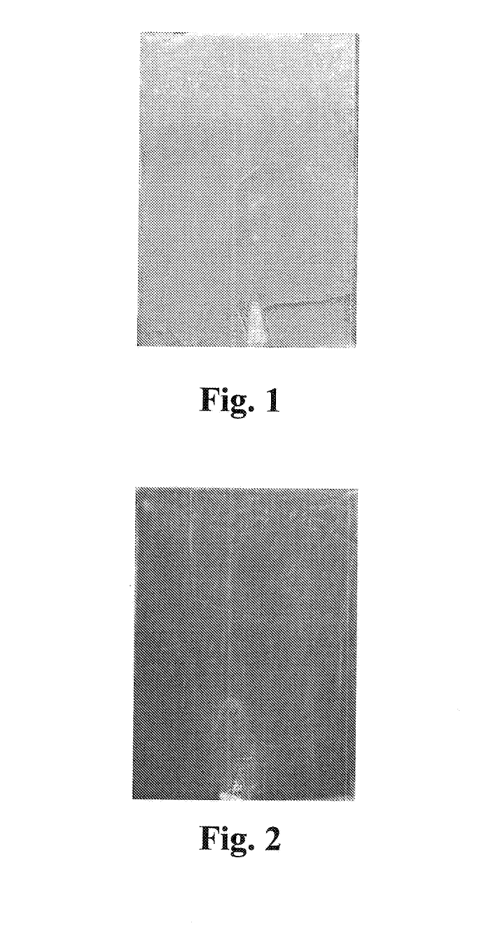

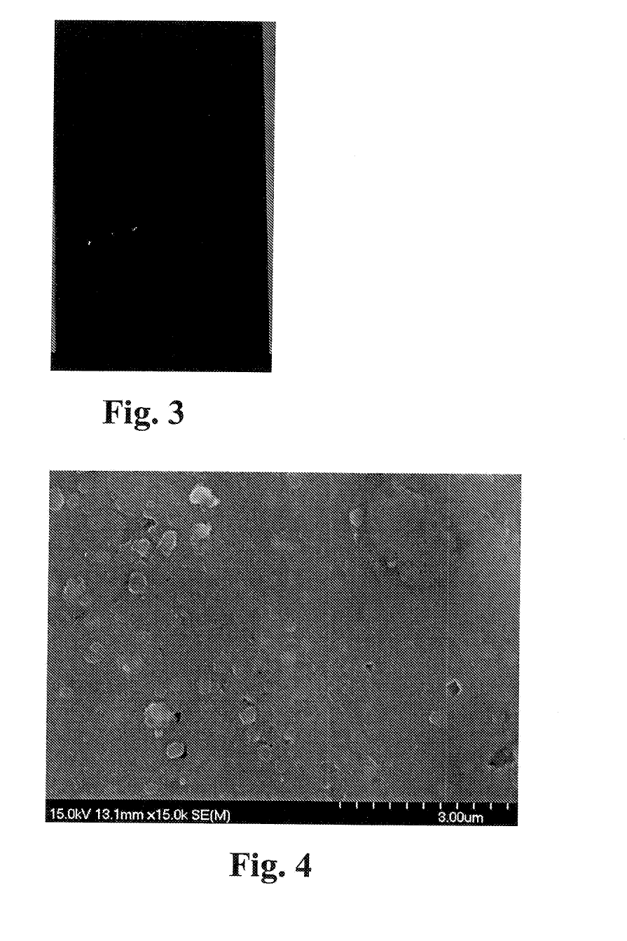

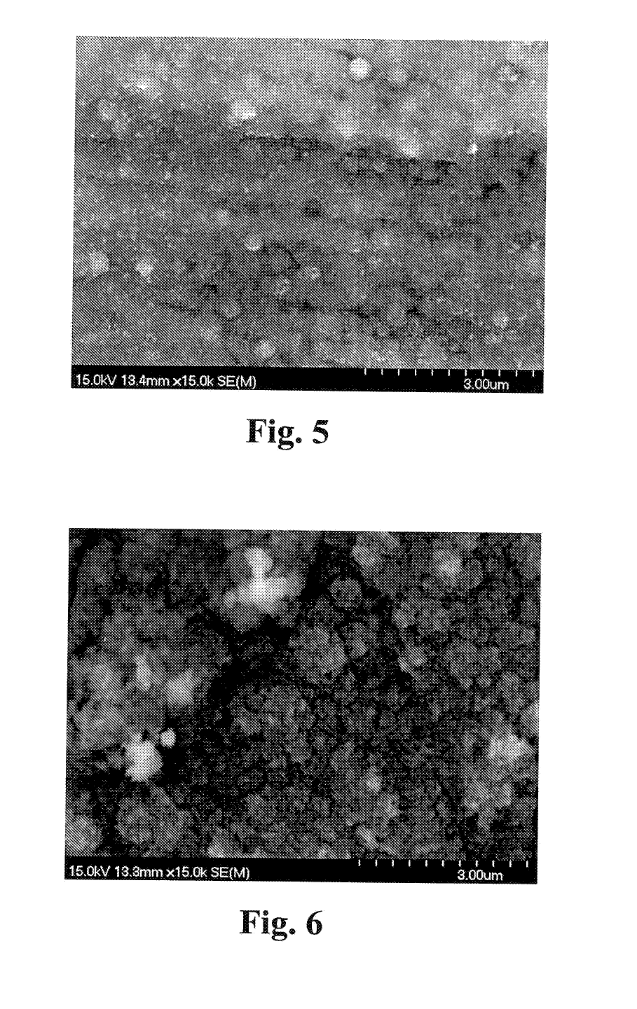

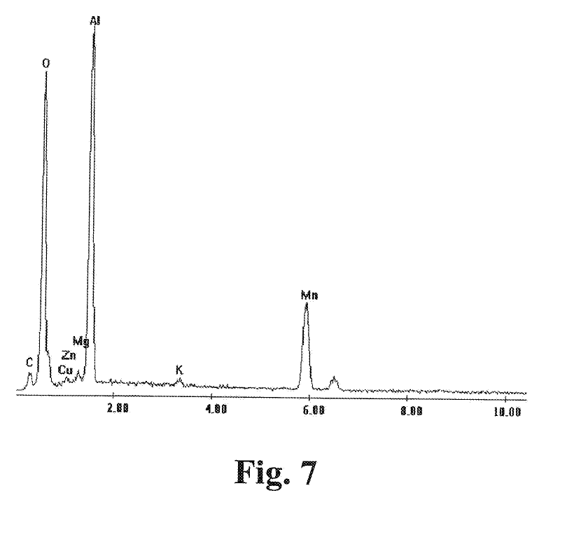

The presence of nodular particles on the surface (see FIGS. 1-3) confirmed the presence of manganese oxide-aluminum oxide conversion coating formation. The SEM photographs of these same samples are shown in FIGS. 4-6. An Energy Dispersive Spectroscopic analysis for manganese of the samples shown in FIGS. 3 and 6 further supports these conclusions (see FIG. 7).

b. XPS Analysis

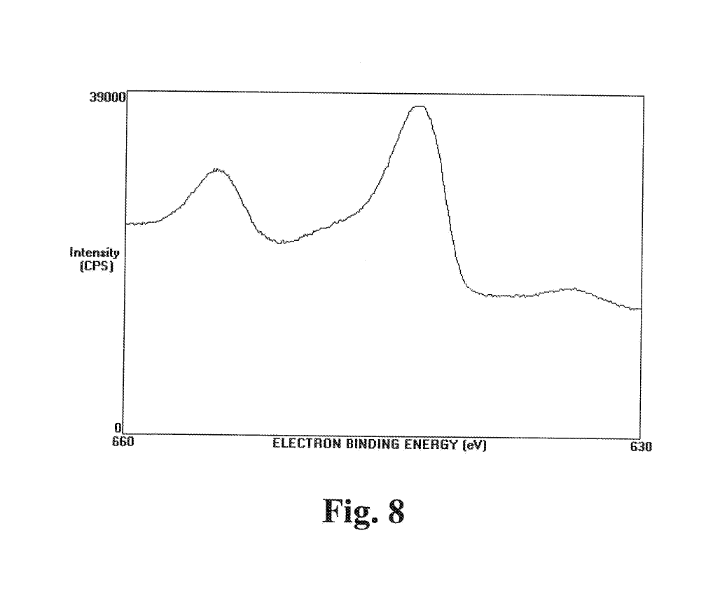

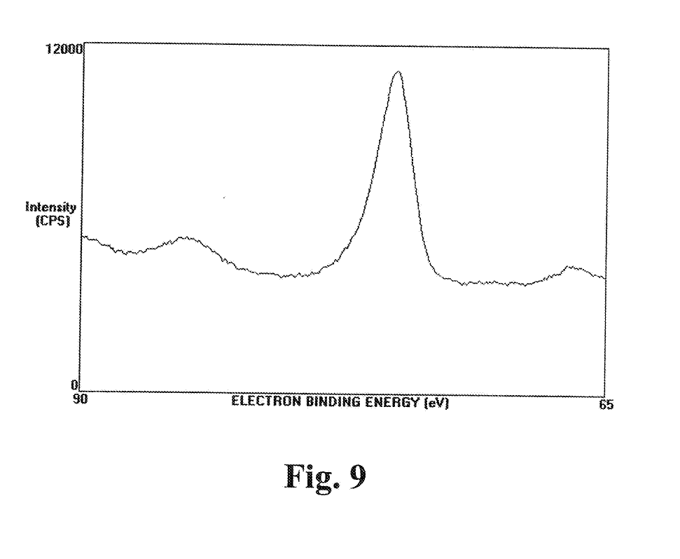

A surface Science Instruments M-probe X-Ray photoelectron spectroscopy (XPS) system utilizing Mg Kα radiation was used to characterize the surface composition of manganese oxide coatings. Samples for XPS were prepared by cutting 1 cm×1 cm pieces from the test coupons, It is known that the binding energy for Mn 2p_{3/2} in the +4 oxidation state occurs at 652.5+/−0.3 eV. The measurements shown in FIG. 8 is consistent with these values indicating formation of MnO₂. Also, the XPS analysis showed the presence of aluminum oxide formation (FIG. 9). The formed conversion coating may be mixed in nature, containing manganese oxides and minor quantities of aluminum oxides.

c. Organic Coating Observations

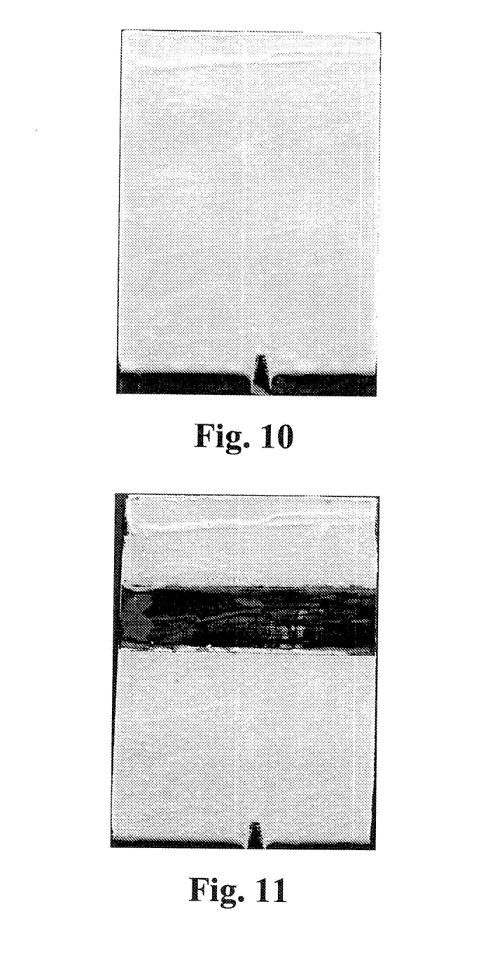

Autodeposition of organic polymer facilitated by manganese cations produced a uniform deposition of the polymer latex. Moreover, depending upon the initial thickness of the manganese oxide layer and immersion time of this oxide coated panel in the autodeposition bath, a layer of manganese oxide conversion coating can be retained, as shown in FIGS. 10-11. This layer of manganese oxide may provide additional protection for the alloy surface.

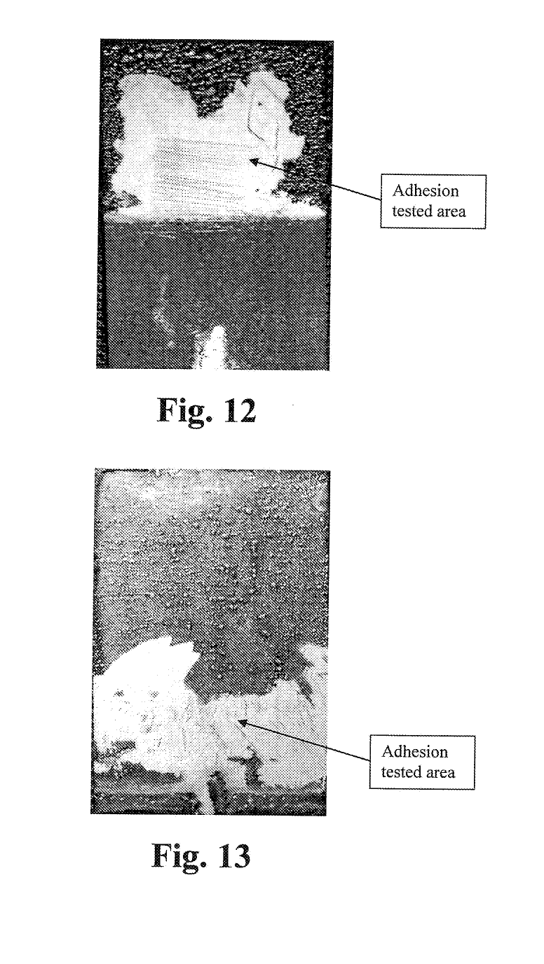

Coatings prepared from hybrid mini-emulsion #1 produced a film with a high T_{g} as the film was observed to be brittle. The resultant coating also had poor adhesion, as determined by cross hatch/tape adhesion testing (ASTM No. D3359). The adhesion and flexibility of the coating was increased in the subsequent formulations by replacing part of the MMA monomer with a BA monomer (#2 and 3 in Table 1). Further increases in the BA monomer percentage produced films with good coalescence in wet conditions. However, these coatings were detached from the panel due to very poor adhesion to the underlying metal surface at wet and cured conditions. FIG. 12 shows a film formed from batch #2 on an aluminum alloy where the manganese oxide conversion layer was formed by 2 minutes of immersion in the conversion coating solution. FIG. 13 shows a film formed from batch #2 on an aluminum alloy where the manganese oxide conversion layer was formed by 1 minute of immersion in the conversion coating solution.

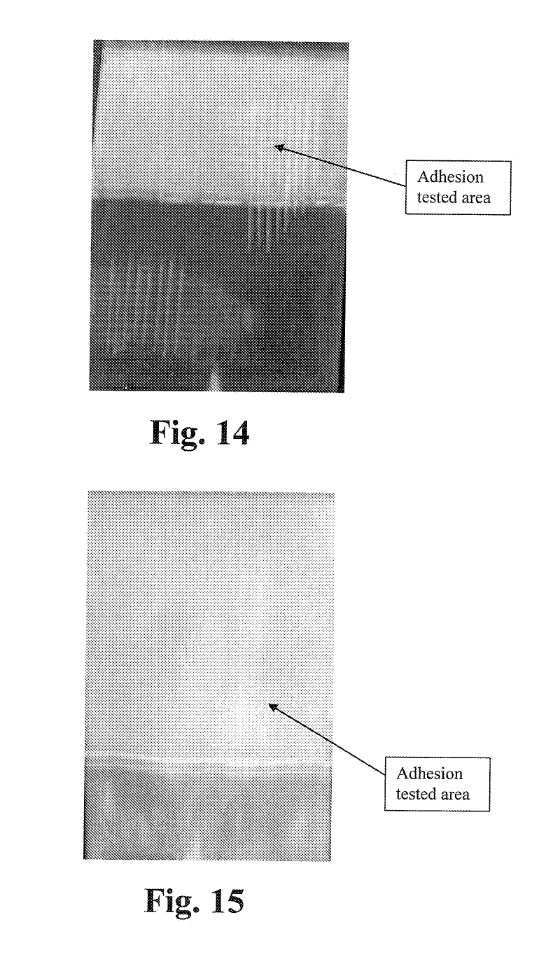

The wet adhesion and subsequent dry film adhesion were improved by incorporating a chain extended epoxy in the hybrid mini-emulsion formulation. Dry adhesion was also highly dependent upon the manganese oxide layer thickness. Higher manganese oxide thicknesses produced a loose oxide layer on the aluminum panel surface, resulting in adhesion failures. FIG. 14 shows the adhesion results of a film formed from batch #5 on an aluminum alloy where the manganese oxide conversion layer was formed by 3 minutes of immersion in the conversion coating solution. FIG. 15 shows a film formed from batch #5 on an aluminum alloy where the manganese oxide conversion layer was formed by 1 minute of immersion in the conversion coating solution.

d. Coating Bath Stability

Autodeposition of ferrous material is controlled by a generation of ferric ions and ferric fluoride complexes that reduce ferrous ion concentration in the coating bath over a period of time. Since this chemistry is absent in manganese ion generation from the soluble manganese oxide coating, there is a possibility for accumulation of Mn²⁺ ions in the bath over a period of time. This high concentration of Mn²⁺ ions will eventually destabilize the entire coating bath. The accumulation of M²⁺ cations can be controlled by removal of the manganese ions by passing the emulsion through cation exchange resins or other metal chelating agents.

### Comparative Examples

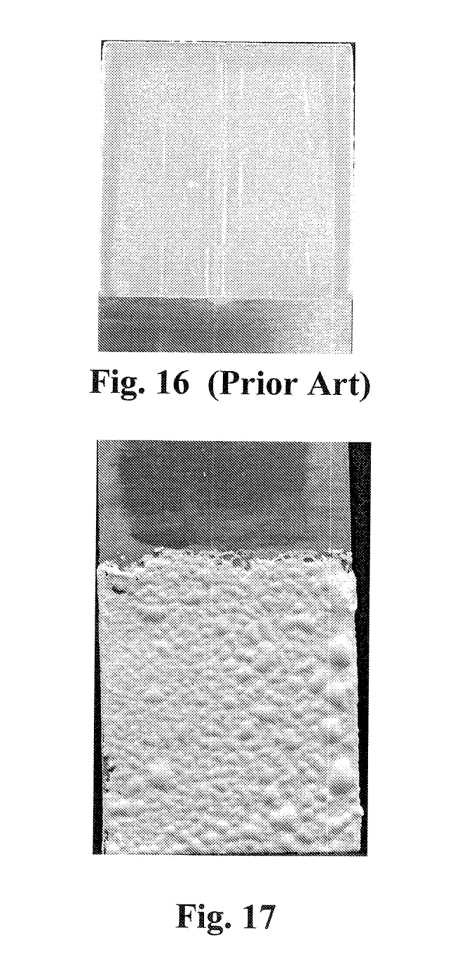

Autodeposition on aluminum alloy 7075 was carried out as described above, but without the use of a manganese oxide coating on the aluminum surface. This prior art process produced a very thin coating with a much higher coagulation on the panel edges. The surface inactivity of the aluminum alloy 7075 panel in the coating bath was evident from the deposition yield, shown in FIG. 16.

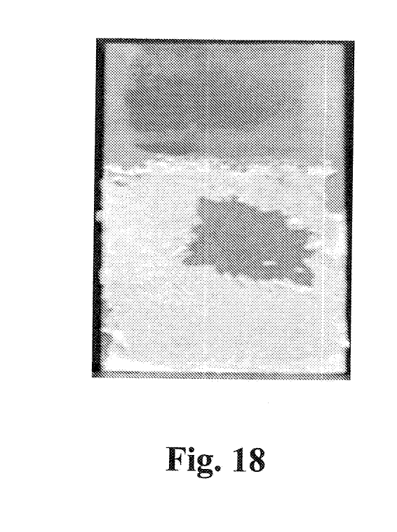

The prior art autodeposition process (i.e., without the use of a manganese oxide coating) was repeated, but with the addition of hydrogen peroxide to the autodeposition bath in an amount of about 1%. Incorporation of the oxidant gave rise to an instant increase in the bath activity resulting in a faster deposition rate and higher film build-up. This resulted in hydrogen evolution through the coating and bubble formation of the coating in wet conditions (i.e., after a water rinse of the non-cured film) as shown in FIG. 17. The deposited polymer showed very little adhesion in wet conditions (see FIG. 18). Also, the corrosion chemistry continued in wet conditions after the removal of the panel from the coating bath.

We claim:

1. A method of preparing a coated metal or metal alloy, said method comprising:
providing a conversion-coated metal or metal alloy comprising a conversion coating including a metal; and
contacting said conversion-coated metal or metal alloy with a composition comprising a component dissolved or dispersed in a solvent system, said component being selected from the group consisting of monomers, oligomers, polymers, and mixtures thereof, wherein said contacting causes said component to deposit on said conversion-coated metal or metal alloy and form the coated metal or metal alloy.

2. The method of claim 1, wherein said conversion-coated metal or metal alloy comprises a metal oxide-coated metal or metal alloy.

3. The method of claim 2, wherein said providing comprises at least partially immersing a metal or metal alloy in an aqueous solution comprising metal ions to form the metal oxide-coated metal or metal alloy.

4. The method of claim 1, wherein during said contacting the conversion coating generates metal ions.

5. The method of claim 2, wherein during said contacting the metal oxide on said metal oxide-coated metal or metal alloy generates metal ions.

6. The method of claim 4, wherein during said contacting the conversion coating generates metal ions at a rate of from about 1 mg metal ions/ft²/minute to about 1,000 mg metal ions/ft² minute.

7. The method of claim 4, wherein said metal ions generated by the conversion coating cause said components to coagulate and deposit on the conversion-coated metal or metal alloy to form the coated metal or metal alloy.

8. The method of claim 6, wherein a layer of conversion coating remains on the final coated metal or metal alloy.

9. The method of claim 1, wherein said contacting results in essentially no hydrogen being generated.

10. The method of claim 1, further comprising heating the coated metal or metal alloy to sufficiently high temperatures so as crosslink the coating on said coated metal or metal alloy.

11. The method of claim 10, wherein said crosslinked coating has an average thickness of from about 1 μm to about 100 μm.

12. The method of claim 3, wherein said aqueous solution further comprises an acid.

13. The method of claim 3, wherein said aqueous solution has a pH of from about 0 to about 5.

14. The method of claim 13, wherein said aqueous solution has a pH of from about 2 to about 4.

15. The method of claim 3, wherein the metal ions in said aqueous solution comprise ions of multivalent metals selected from the group consisting of the transition metals, zinc, and mixtures thereof.

16. The method of claim 15, wherein said metal ions comprise those selected from the group consisting of manganese ions, molybdenum ions, cerium ions, tungsten ions, vanadium ions, cobalt ions, zirconium ions, titanium ions, iron ions, zinc ions, copper ions, and mixtures thereof.

17. The method of claim 1, wherein the metal or metal alloy of said conversion-coated metal or metal alloy is selected from the group consisting of aluminum, magnesium, titanium, copper, bronze, iron, alloys of the foregoing, and galvanized metal substrates.

18. The method of claim 1, wherein said composition comprises a mini-emulsion.

19. The method of claim 1, wherein said composition further comprises a crosslinking agent and a catalyst.

20. The method of claim 19, wherein said crosslinking agent is selected from the group consisting of blocked isocyanates, aminoplasts, blocked polyisocyanates, and blocked polycyanurates.

21. The method of claim 19, wherein said catalyst is selected from the group consisting of p-toluenesulfonic acid, dialkyl metal dicarboxylates, and mixtures thereof.

22. The method of claim 1, wherein said component is selected from the group consisting of epoxy resins, acrylates, polyacrylates, acrylic acids, polyacrylic acids, isocyanates, polyisocyanates, polyesters, polyurethanes, siloxanes, silicones, polyamides, polyolefins, carbowaxes, hydroxyl functional-siloxanes, hydroxyl functional-silicones, hydroxyl functional-polyamides, hydroxyl functional-polyolefins, and mixtures thereof.

23. The method of claim 10, wherein said contacting step results in a coated metal or metal alloy that is essentially free of defects.

24. The method of claim 2, wherein the metal oxide of said metal-oxide coated metal or metal alloy is selected from the group consisting of oxides of metals selected from the group consisting of transition metals, zinc, and mixtures thereof.

25. The method of claim 1, wherein said composition further comprises an ingredient selected from the group consisting of water, co-solvents organic solvents, organic polymers, hexadecane, additives, coloring agents, surfactants, pigments, anti-corrosion additives, coalescing co-solvents, and mixtures thereof.
